(19) United States
(12) Patent Application Publication
(10) Pub. No.: US 2008/0021980 A1
(43) Pub. Date: Jan. 24, 2008

(54) Transmission Of Commmunication Between Data Transmission Networks

(75) Inventors: Jouni Korhonen, Riihimaki (FI); Tero Jalkanen, Helsinki (FI); Jussi Laukkanen, Helsinki (FI)

Correspondence Address: COHEN, PONTANI, LIEBERMAN & PAVANE, 551 FIFTH AVENUE, SUITE 1210, NEW YORK, NY, 10176, US

(73) Assignee: TeliaSonera Finland OYJ, Helsinki (FI)

(21) Appl. No.: 10/593,987

(22) PCT Filed: Mar. 16, 2005
(86) PCT No.: PCT/FI05/50085

§ 371 Date: Oct. 11, 2006

(30) Foreign Application Priority Data
Mar. 25, 2004 (FI) 200445100

(51) Int. Cl. G06F 15/16; G06F 15/173

(52) U.S. Cl. 709/218; 709/223

(57) ABSTRACT

The invention relates to transmitting a communication from a data transmission network to a receiving data transmission network. The communication is directed to a transmitting network element in the receiving data transmission network on the basis of this network address. The network address of the network element is queried from a private name server of the receiving data transmission network, after which said connection is directed to said network element. In addition, the invention relates to a system and a name server for implementing the method according to the invention.

The invention relates to a method, a system and a name server for the transmission of communication from a data transmission network to a receiving data transmission network.

In a multi-operator environment, i.e. in such a data network environment where an Internet connection can be provided for one terminal via several different service providers, the transmitting operator must know which network element of the receiver the transmission is performed to. Thus, the transmitting operator must know all the receiving network elements of the receiving operator in order for the transmission to be successful.

In known methods the operators have maintained different static lists or databases, where the network elements of the receiving operator are stored. In other words, each operator has stored data on the network elements used by each receiving operator. For example, for this purpose the GSM Association has provided an IR.21 database for solving operator roamings and interworking, which database has all the operator information necessary for forming connections.

In the communication between network operators, a problem can be detected between a closed DNS hierarchy (i.e. Domain Name Service) in an interconnection network and a DNS hierarchy of a public Internet connection, which problem relates to determining domain names. The domain server is used in a known manner in the Internet for converting domain names (FQDN, Fully Qualified Domain Name) into network addresses (such as IP addresses). In some situations, such as, for example, in the operation of an IMS service platform (IP Multimedia Subsystem), it is possible that such domain names have to be determined, which should not be found in a public DNS system, but which, however, have domains determined by a public DNS system. At the same time, said domain names should not be found in the DNS system of a closed interface network. For example, in the operation of an IMS system, it may be necessary to determine, on the basis of the domain name of an opposite operator, the network address of a corresponding I-CSCF element in order to route a message there. The necessary network address of the I-CSCF cannot, however, be queried from DNS servers in the Internet, because they cannot store the network addresses of the internal elements of operators for data security reasons.

The static lists and configurations used in known methods do not provide a centralized or distributed solution for acquiring data. Static lists and configurations require maintenance, because there can be hundreds of cooperating operators and the server addresses in them may change or servers may be added or removed. Because of this, there is a need for an improved method and system form performing database queries. In addition, a method for determining the addresses of the internal network elements of the described IMS system is needed. The present invention provides one solution for meeting the above-described requirements.

As mentioned above, the present invention relates to the connections between data transmission networks of operators in a multi-operator environment, for example IMS environment. The purpose of the invention is to make it possible for the transmitting operator to query before forming a connection, the receiving operator for the data of the network element required for the transmission. By means of the invention the transmitting operator receives the necessary data of the servers of the receiving operator, which can typically be changing. As an example can be mentioned a network address of a multimedia messaging center, which is required for forming a connection to the center and for transmitting a multimedia message via an interface network. If desired, the receiving operator can change the network address of the multimedia messaging center or, for example, add another multimedia messaging center. Thus, it must be solved how the load is distributed and the messages are transmitted between these two centres.

The invention describes a method, by utilizing which it is possible, instead of direct fixed connections, to make a dynamic query to the private database of the receiving operator, which provides an answer on the properties of the required network element (such as, for example, the network address of the I-CSCF of the receiving operator). Thus, the transmitting operator does not have to maintain and store these properties.

With the system according to the present invention, the above-described problem of determining domain names can be addressed in such a manner that each operator knows only the address of a private name server of a roaming or interworking operator, which private name server is arranged to determine and store the desired domain names and network addresses of the internal elements of the operator. This kind of a method reduces the amount of statically formed data between roaming operators (because the operator does not need to know the addresses of the different servers of the roaming operator, but only the address of said private name server).

To put it more precisely, the present method is primarily characterized in that before controlling a communication, the network address of said transmitting network element (I) is queried from the private domain name server (PD) of the receiving data transmission network (B), after which said connection is directed to the network element in question.

The system according to the invention is primarily characterized in that the receiving data transmission network (B) comprises a private name server (PD), from which the transmitting data transmission network (A) is arranged to query the transmission data of the network element (I) that is the target of the communication, and which private name server comprises transmission data of the network elements of the data transmission network (B) in a centralized manner.

In addition, the name server according to the invention is primarily characterized in that the name server is a private name server, which is arranged to verify the transmission data of the desired network element on the basis of a query and to return said transmission data to the querying party.

With the present invention, no static lists are needed, which reduces manual work. Typically the operators change their own data, for example a network address may change, which results in that every interworking operator must manually update their own list or in some other manner change the addresses of communication. Automation reduces the possibility of human errors in, for example, updating network addresses.

Many problems are solved by providing the transmitting operator the address of only one internal database of the receiver. The transmitting operator can thus directly query from that database, for example, all the network addresses of multimedia messaging centres, in which case the receiver can freely vary the addresses of its own center without the transmitter having to update this data. The only information that the transmitting operator must have is the address of the private database of the receiver, all other required information can after that be directly queried from this database.

In addition, with the present invention the use of public domain names is possible in a private interface network. The invention is useful especially in a GRX network, where the DNS service of public Internet cannot be utilized because the GRX addresses must remain within the GRX network and they cannot be used outside said network. In the following, the invention will be described more in detail with reference to the appended drawings, in which

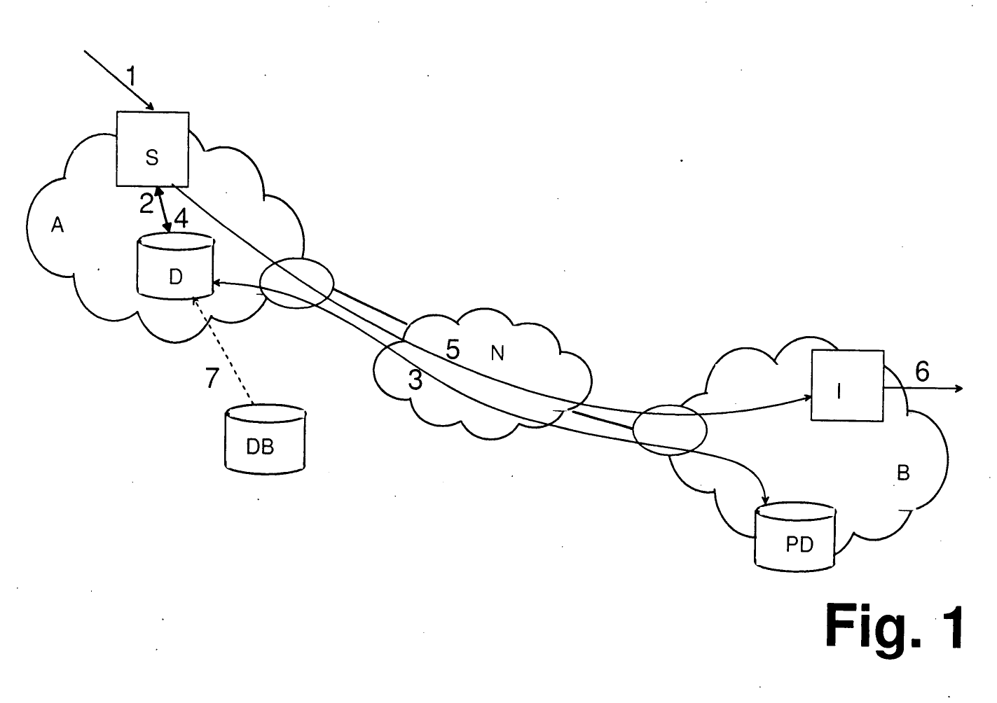

FIG. 1 shows an example of a data network system, which utilizes the domain name server according to the invention.

FIG. 1 shows the main principle of the solution according to the invention. The system according to the invention comprises operator networks A, B and the network elements comprised by them, which are known as such, for example, domain name servers. The network elements comprised by the operator networks A, B depend on the network type in question and are known as such. For example, in FIG. 1 the operator networks A, B are IMS networks, in which case they comprise elements known for IMS networks, such as at least the I-CSCF and S-CSCF implementing the call/session control function. In the example of FIG. 1, the I-CSCF (Interrogating-CSCF) element I shown in the operator network B functions as a so-called contact point and forms an access to said operator network B. All the sessions addressed to a subscriber of the operator network B are first received in said element I. The control element S shown on the operator network A side, such as a S-CSCF element, performs session control services for the terminal. User registration and identification of registered users takes place in a known manner in this control element S, which can also handle session control on behalf of the registered users. For simplification, other elements belonging to the network have been left out of FIG. 1, because they operate in the method of the invention in a manner known as such and are not necessarily dependent on the arrangement according to the invention. In addition, it is to be noted that the operator networks A, B can comprise such elements, which are shown in connection with only one operator network A or B.

In addition, the operator network A may comprise a local name server D (DNS, Domain Name Server), which comprises a resolver, which converts, for example, fully qualified domain names (FDQN) into IP addresses in a manner known as such. In addition, it is possible to arrange a connection 7 to the operator network to an operator database DB, such as, for example, an IR.21 type operator database. In addition, according to the present invention, a private operator name server PD is arranged in the operator network B, which server stores the network addresses of the internal elements of the operator network and other necessary information for forming a connection.

The operation of the above-described system is described further with reference to FIG. 1. A subscriber of the operator network A, called A-subscriber, makes a connection (1), for example, by sending a SIP INVITE message to a subscriber of the operator network B, called B-subscriber (e.g. b.subscriber@operatorB.com). Both said subscribers are IMS subscribers in this example. The A-subscriber uses the public network address of the B-subscriber (such as IMS address, public SIP URL), where the area of the operator network B (operatorB.com) is a public registered domain name on the Internet. The control element S of the operator network A, here the S-CSCF element, takes care of directing the message toward the operator network B.

The control element S of the operator network A makes a query (2) to a local name server D. This local name server D comprises data about the network address of the private operator name server PD of the operator network B. The local name server D can have searched the desired address data, for example, form an operator database DB.

The local name server D (3) queries from the private name server PD of the operator network B the address of the contact point of said network B, such as the I-CSCF element. After receiving this, the local domain name server D of the operator network A transmits (4) the data to the control element S, which further transmits (5) the communication to the contact point I of the operator network B. This contact point I operates as access to the operator network B and thus routes the message further to the B subscriber.

With the system according to the described invention, the local name server D of the operator network A does not necessarily have to comprise more than one network address for each operator they have communication with. The private operator name server PD according to the invention comprises the network addresses of the servers of said network operator, in which case the operator network A must only know the address of said private operator name server PD. This private operator name server PD is, according to the invention, added to the operator network, and it does not directly belong to the interface network (such as GRX) or the public Internet. The private operator name server PD according to the invention can be based on a DNS solution or be, for example, a LDAP database (Lightweight Directory Access Protocol), which is a directory service known as such.

It is obvious that the system according to the invention can be implemented in some other type of network environment than said IMS system as well. Thus, the subscribers must also be subscribers of the network environment in question and thus the internal network elements of the data transfer networks can be characteristic to this network. It is obvious that the idea of the invention can be applied in connection with different network elements.

The invention is described above according to one embodiment. It is, however, to be noted that the solution according to the invention can be applied in other environments as well. Thus, the invention is not limited to the embodiment described above, but the features of the invention may vary within the scope of the appended claims.

1. A method for transmitting a communication from a data transmission network to a receiving data transmission network, which data transmission networks are different to each others, where the communication is directed to the transmitting network element in the receiving data transmission network on the basis of this network address, wherein a first connection to the receiving data transmission network is formed for querying the network address of the transmitting element of the receiving data transmission network from the private name server before directing the communication, after which the communication is directed to said network element.

2. The method according to claim 1, wherein said private domain name server comprises in a centralized manner, in addition to the network address in question, the transmission data of the other network elements of said receiving data transmission network.

3. The method according to claim 1, wherein a query is performed from the local name server of the transmitting data transmission network to the local domain name server of the receiving data transmission network.

4. The method according to claim 3, wherein the network address data of both said private name server and the private name servers of other data transmission networks is maintained in said local name server.

5. A system for transmitting communication, which system comprises a transmitting data transmission network and a receiving data transmission network, which data transmission networks are different to each others, and means of directing communication from the transmitting data transmission network, as well as a transmitting network element arranged in said receiving data transmission network for receiving the communication, wherein the receiving data transmission network comprises a private name server, whereby the transmitting data transmission network is arranged to form a first connection to the receiving data transmission network in order to query the network address of the transmitting element of the receiving data transmission network from the private name server before directing the communication, whereby the transmitting data transmission network is arranged to direct the communication to said network element.

6. The system according to claim 5, wherein the transmitting data transmission network comprises a local name server, which is arranged to perform a query from said private name server.

7. The system according to claim 5, wherein the private domain name server is a LDAP database.

8. The system according to claim 5, wherein at least one of the data transmission networks is an IMS data transmission network.

9. The system according to claim 8, wherein the transmitting network element is an I-CSCF contact point.

10. A name server for storing names, which name server is arranged in a data transmission network, wherein the name server is a private name server, which is arranged to verify, on the basis of the query from another data transmission network separate to said data transmission network, the transmission data of the desired network element and to return said transmission data to the querying party.

11. The name server according to claim 10, wherein the name server is an LDAP database.
